(19) United States
(12) Patent Application Publication
(10) Pub. No.: US 2015/0294269 A1
(43) Pub. Date: Oct. 15, 2015

(54) METHOD AND SYSTEM FOR HIERARCHAL EVENT MANAGEMENT

(71) Applicant: Achilles Kornaros, Chicago, IL (US)

(72) Inventor: Achilles Kornaros, Chicago, IL (US)

(21) Appl. No.: 14/250,377

(22) Filed: Apr. 10, 2014

(51) Int. Cl. G06Q 10/10

(52) U.S. Cl. CPC G06Q 10/10

(57) ABSTRACT

A method and system is disclosed for providing hierarchal organization and communication in real time within an event management framework. The present invention efficiently coordinates and communicates information and events in real time within the system and transmits such messages to a desired recipient.

### BACKGROUND

### Summary of the Invention

A method and system is disclosed for providing hierarchal organization and communication in real time within an event management framework. The present invention efficiently coordinates and communicates information and events in real time within the system and transmits such messages to a desired recipient. The present invention provides a more efficient and cost effective way to manage the operations and logistics of an event with communication to event personnel for functions including registration, accreditation, organization, inventory control, supply/equipment distribution, scheduling, medical patient tracking, real-time reporting, and dynamic messaging by utilizing a web-based application, mobile smart phone, or tablet device.

### BRIEF DESCRIPTION OF DRAWINGS

FIG. 1 illustrates the hierarchy of the elements or entities of an event that will be organized using the present invention.

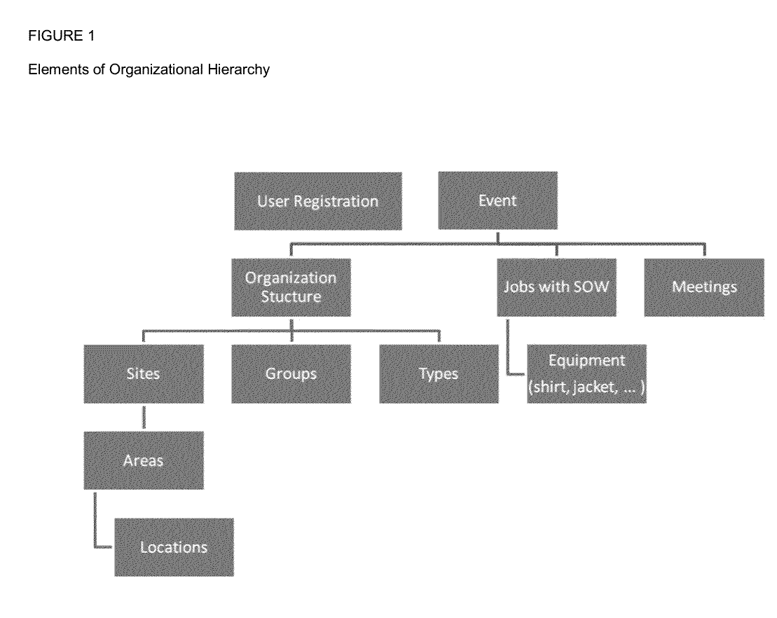

FIG. 2a illustrates the flow chart of management of event personnel using the present invention.

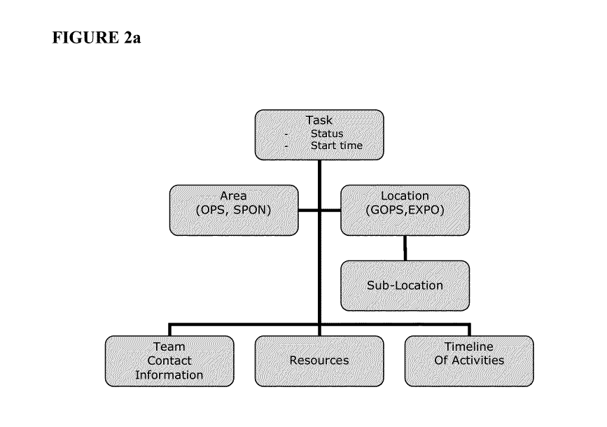

FIG. 2b is an illustration of the method of the present invention showing the steps for the management and communication in real time of event personnel for an event.

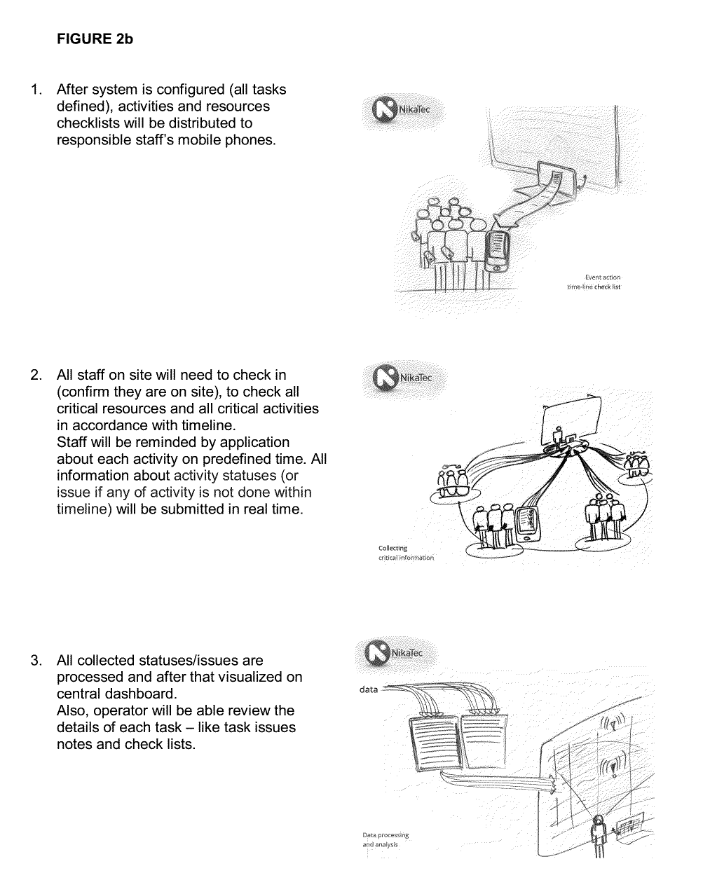

FIG. 3 illustrates the architecture of the present invention for medical patient tracking at an event.

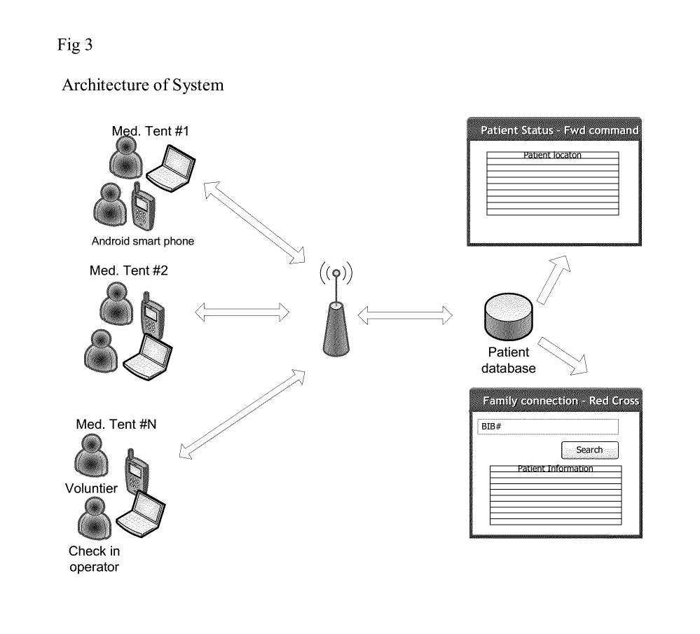

### DESCRIPTION OF THE INVENTION

The present invention provides for a system for the efficient management of events of any size by allowing for the tracking of information and events, and communication of such information and events to all specified recipients in real time. Such real time communication allows all members of a team or organization to be kept informed of the status of any event, personnel, equipment or any other type of information and also allows such members to communicate in real time as to any such event, personnel, equipment or any other type of information. The present invention further provides a system to also track the status of any event, personnel, equipment or any other type of information in a central database and to communicate such information to all users with access.

Although the present application may discuss various embodiments concerning sporting event management such as racing competitions including marathons, duathlons, triathlons, and any other racing event, it must be understood that the present invention may be directed to event management of any type of event.

The system of the present invention shall be comprised of a server module and a mobile module. The server module of the present invention may be a web based application that provides for the hierarchal structuring of the event management; the collection, correlation and storage of information relating to participants, users and events; and the communication of all relevant information to participants, users and any specific recipients in real time. The mobile module may be any mobile device capable of communicating with the server/central database. The mobile module shall be at an on-site location which allows users to be able to submit, in real time, status of his/her job timeline.

Although the present application generally describes software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The present invention further provides a system for structurally automated decision support for the organizers of the event. The system allows for information to be communicated to key people associated with the organizers of an event. The system further allows for communication of information to flow from the actual event to a preselected number of individuals on a “need to know” basis. For example, if a participant is injured in a racing event, the personnel in the medical area can notify all needed individuals, such as organizers of the event, medical staff, family members of the participant.

Resource Management Module

The present system is configured to manage the resources and personnel at an event using various elements of the event and personnel for such event. Independent of an actual event, each personnel or user of the system will enter his or her information to a central system/database/server of the system which may include personal identifiers, contact information and digital photo. After such information has been entered, a unique identifier is assigned to each user that shall be such user's identifier for all future events. In the event of a new “event” to be managed, elements of the event are entered into the system as a new event. The elements of the new event may include the name, date, registration timelines, number of participants and any other relevant information. The hierarchy of the management of the event shall then be configured including the site, area, location and/or sub location, group and type and entered into the central database. The hierarchy of the management is further defined by creating a job's list specific for each organizational structure unit and such hierarchy is entered into the central database. The system may further define items such as statements of work for each job description, pay scales, and equipment related to each job description. The system may then assign the initial jobs to specified users.

In one embodiment, personnel may be assigned as site managers to administrate the site's areas, location and any other associated unit in the organization's structure hierarchy. A user is then assigned for each job in the associated organization structure. The system may generate an invitation to the specified user at which point the user may accept and the site manager would confirm such acceptance. Each such step may be completed using a mobile device. The system may allow details of the user's accommodation information to be entered and stored such as hotel information, air fare and such other relevant information.

One of the benefits of the present invention is that meetings may be scheduled and communicated to the users by generating an invitation to the specified user at which point the user may accept. In the present invention, the attendance at such meetings may be tracked and stored for future reference.

The system also allows the management of the event to not only be communicated in real time to any subordinates but also allows the communication to be archived and stored. Site managers can propagate organization structure unit administration/management to their subordinates or any specified user.

In one embodiment, the system may be configured to track all personnel's or team's jobs and job completions. In such embodiment, the system is configured by defining all tasks for each personnel or team. After such tasks, activities and resources have been entered into the central database or system, such information concerning tasks, activities and resources will be distributed and communicated to the specific personnel's communication device such as cellular phone or other electronic device. User will also be assigned with credentials, rounds, badges according to the assigned job.

All personnel on site will need to check in to confirm they are on site, to check all critical resources and all critical activities in accordance with a specified timeline. The system will send reminder notices to each personnel about each activity on predefined time. All information about activity statuses (or issue if any of activity is not done within timeline) will be submitted in real time by the system. All collected statuses or issues are processed by the system and after that visualized on central dashboard. Also, an operator will be able review the details of each task such as task issues notes and check lists.

Medical Patient Tracking Module

The present invention provides a system and method for patient tracking in a sporting event. In such system and method, information about patient location, check in and check out time and other important information from each medical area may be obtained in the field via the mobile module and entered in the central system/server/database by syncing that data with the central system/server/database.

The present system further allows for patient tracking in a sporting event. The system provides for collection, correlation, storage and communication of information about patient location, check in and check out time and other important information from each medical site or tent. All relevant information may be obtained in the field and entered in a central database by syncing that data with the central system. The system provides for participants or spectators who need medical attention in a medical facility or at an Aid Station on the event course to be tracked in real-time when being admitted as well as being transported to a nearby Hospital. Each participant may be assigned a unique identifier that may be used to track the participant during the race and throughout his or her time at any medical site or facility. Information concerning each participant may be entered into the system prior to the event and correlated to the specific participant by correlating such information to the participant's unique identifier. The participant's unique identifier may be associated with the participant's BIB number and incorporated into a unique wrist band number for the participant. If a participant enters a medical area, the participant will be assigned to a specific Section/Bed number of the Medical area to which they are being admitted. The participant will be tracked using the participant's unique identifier. Information concerning the participant shall be communicated to the central system using the participant's unique identifier via a user's mobile device such as a mobile phone or tablet. The system provides for dynamic email/text messaging to notify users, event staff groups or teams, stored emergency contacts, and participants needing language translation of the status of the participant admitted or checked in to a medical area. Such notifications may also be generated when such participants that are checked in to a medical area require translation services.

One of the benefits of the present invention is that the system is able to provide customized real-time reporting of the events of the medical areas including the summary of the total number of admitted participants with weather conditions per medical location for a given hour, percentage of chief complaints, diagnosis details, and statuses and other relevant information. The system further allows for better communication to family members and emergency contacts looking for participants receiving medical care and providing their exact location in real-time.

Inventory Module

The present invention provides a comprehensive web and mobile based solution for inventory management, merchandise distribution, and vehicle tracking at an event. The inventory module allows for quick and easy integration into other modules for custom requirements for each event. The present system is configured to manage the inventory and equipment used by the personnel at an event. For each new event, information concerning the inventory or equipment required for such event may be entered into the database and correlated to the event, including but not limited to the type of equipment, number of equipment, any reference numbers or identification information for such equipment, space allocated for storage of such equipment, and personnel authorized to check out and use such equipment. The type of equipment for each event may vary from event to event and may include tools, merchandising items, clothing, computing devices, communication devices, vehicles for transport, and any other items specific to the event.

For each piece of equipment, the system may be configured to track the item from the start of the event to the finish. The system first generates an identifying code for each piece of equipment such as bar codes or other reference codes that is specific to that item. The generated bar codes or other reference codes may be affixed to the item and may be read with a scanner or conventional reader. The purpose and initial location and sub-location of such piece of equipment may then be entered into the database. A specific list of authorized personnel allowed to check out that piece of equipment is then entered into the database and correlated to such specific item. In one embodiment, the system may be configured such that a number of personnel within a hierarchal level or sub level may be entered into the database and only personnel within such level may be authorized to check out that specific item.

In one embodiment, the equipment may be split into categories or sub categories specific for each event. The equipment may further be categories or inventoried with custom units of measure specific to the event.

Once the system has been configured with the number of equipment, the identifying codes for each piece of equipment, the purpose and initial location of such equipment and the authorized personnel for each piece, the system is capable of tracking the equipment from the start of an event to the finish. Each personnel may be assigned a specific piece of equipment or inventory of items for which such user may be responsible. The system may communicate such assignments to the user to which the user must confirm such assignment. Further, the user may be required to log in using his mobile device each time the user removes a piece of equipment from its original location. By requiring the user to log in, the system is able to track the location of all items and further is capable of determining the user of the items at all items. All such tracking information may be archived with the system.

The system may be programmed to generate inventory reports based on the archived information to allow users to determine if there are any missing items. The system may further generate sales orders on any needed items of equipment based on the configuration of equipment needed for each event. The system may further provide for the means for bulk importing of items.

In one embodiment, the system may be configured to manage the distribution of merchandise at an event. The users may compile merchandise requests directly from an Event Staff Registration module. The system may then be configured to track the distribution of the merchandising based on the input from users filling orders of such merchandise. Once a request or order is fulfilled, such information may be entered into the central database. The user may further enter information concerning any exchanges of merchandise. The system may be programmed to generate reports based on the archived information to allow users to determine the number of sales and inventory. The system may further be programmed to create forecasts based on actual fulfilled merchandise in the past.

In one embodiment, the system may be configured to track vehicles used at an event. For each vehicle, the system may be configured to track the use of the vehicle from the start of the event to the finish. The system first generates an identifying code for each vehicle that is specific to that vehicle. The identifying code may be affixed to the vehicle. A specific list of authorized personnel allowed to use that vehicle is then entered into the database and correlated to such specific vehicle. In one embodiment, the system may be configured such that a number of personnel within a hierarchal level or sub level may be entered into the database and only personnel within such level may be authorized to use the vehicle. In another embodiment, users of any hierarchal level may request that use of a vehicle and the managing personnel must authorize such use.

Once the system has been configured with the number of vehicles, the identifying codes for each vehicle, and the authorized personnel, the system is capable of tracking the vehicle(s) from the start of an event to the finish. The system may communicate such assignments to the user to which the user must confirm such assignment. Further, the user may be required to log in using his mobile device each time the user moves the vehicle from its original location. By requiring the user to log in, the system is able to track the location of all the vehicles and further is capable of determining the user of the vehicles at all items. All such tracking information may be archived with the system. The system may further generate timed alerts when a user is checking out a vehicle. The user may be required to log in the gas levels at check in and check out using his mobile device each time the user uses the vehicle. The system may further be used to track the available space for vehicles for a specific event by allowing the system to be configured with the available space at an event and the number of vehicles required for such event.

In the event a vehicle is damaged during transport, the user will be required to log in such information using his mobile device in order for the system to track any such damage. Any such vehicles may be marked in the system as out of service to allow all users of the system to be aware of the damage and availability of vehicles.

The system may further be programmed to provide visual in/out board with gas and space meters.

In one embodiment, each key tag for a vehicle may be marked with an identifying code for such vehicle to allow the system to track not only the vehicle(s) from the start of an event to the finish but also such set of keys.

In another embodiment, the items within a vehicle may be tracked. The items stored within a vehicle may be entered into the database and then correlated to such vehicle. The system may then be able to track the user of such vehicle as well as the items packed within said vehicle.

Emergency Alert Protocol

In one embodiment, the system provides a method and ability to alert event staff and event administrators of an emergency in the field. An emergency may be characterized as a weather emergency due to a severe storm; an attack or massive attack on participants, spectators or event staff; or an event that may cause massive panic or loss of control of participants, spectators or event staff. The Emergency Alert Protocol may be triggered by event staff personnel by depressing a panic button on the mobile module. Once the panic button is depressed, the mobile module communicates the emergency alert to the server module and the emergency alert is communicated to an event administrator. Once the event administrator reviews the emergency alert, the administrator may send a message to the server module that will be sent to the mobile module to all pre-designated personnel, staff and/or participants.

1. An event management system providing real time hierarchal organization and communication, the system comprising:
a server module that provides for the hierarchal structuring of the event management, the collection, correlation and storage of information relating to participants, users and events; and the communication of all relevant information wherein the server has a database to collect and store information;
and a mobile module capable of communicating with the server module and accessible by participants, users and any specific recipients in real time.

2. An event management system according to claim 1, wherein elements of an event including the name, date, registration timelines, number of participants and any other relevant information may be stored in the server module.

3. An event management system according to claim 1 wherein a unique identifier is assigned to each user and that such unique identifier shall be stored in the server module for all future events.

4. An event management system according to claim 1 wherein the hierarchy of the management of the event is configured including the site, area, location and/or sub location, group and type and entered into the server module, where the hierarchy of the management is further defined by creating a job's list specific for each organizational structure unit and such hierarchy is stored into the server module; where the system assigns initial jobs to specified users and communicates such jobs to such users via the mobile module.

5. An event management system according to claim 4, wherein all tasks, activities and resources will be stored into the server module, such information concerning tasks, activities and resources will be distributed and communicated to the specific personnel's via the mobile module.

6. An event management system according to claim 1, wherein each participant may be assigned a unique identifier used to track the participant during an event and information concerning each participant is entered into the server module prior to the event and correlated to the specific participant by correlating such information to the participant's unique identifier.

7. An event management system according to claim 6, wherein information concerning the participant, including any injuries or health issues, may be communicated via the mobile module to the server module where such information is further communicated to event personnel or pre-designated spectators.

8. An event management system according to claim 1, wherein information concerning the inventory or equipment required for an event may be entered into the server module and correlated to an event.

9. An event management system according to claim 8, wherein the system is configured to track an inventory or equipment item for the duration of the event and communicate such information to event personnel or administrators via the mobile module.

10. An event management system according to claim 1, wherein an Emergency Alert Protocol allows event staff personnel to alert the administrators of an emergency in the field via the mobile module.

11. An event management system according to claim 10, wherein a message of emergency may be communicated to pre-designated staff personnel, participants and spectators from the server module.

12. An event management system providing real time hierarchal organization and communication, the system comprising:
a server module that collects, correlates and stores information relating to participants, users, events, resources, inventory, equipment and emergency events in the field; and communicates all relevant information;
and a mobile module accessible by participants, users and any specific recipients capable of receiving communications and communicating with the server module in real time.

13. An event management system providing real time hierarchal organization and communication, the system comprising:
a server module having a database that collects, correlates and stores information relating to participants, users, events, resources, inventory, equipment and emergency events in the field; and communicates all relevant information;
and a mobile module accessible by participants, users and any specific recipients capable of receiving communications and communicating with the server module in real time.
